(19) United States
(12) Patent Application Publication
(10) Pub. No.: US 2008/0085011 A1
(43) Pub. Date: Apr. 10, 2008

(54) Method and apparatus for selective exploitation of inherent and/or purposeful load impedance differences and associated virtual impedance

(76) Inventor: Carl N. Nett, South Glastonbury, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/261,179

(22) Filed: Oct. 27, 2005

(51) Int. Cl. H04R 27/00

(52) U.S. Cl. 381/85

(57) ABSTRACT

In a switching device for exploiting impedance differences between at least two loads, connectors are provided for coupling the loads to the switching device. The loads cooperatively define a non-zero virtual impedance. At least one connection point is included for accepting an output from at least one signal generator. The connection point is in electrical communication with the connector. The connector and the connection point cooperate with one another to selectively cause the loads to be interconnected at minimum of at least two of either series, parallel, first load alone, or second load alone, to exploit the impedance differences and/or associated virtual impedance.

### FIELD OF THE INVENTION

The present invention is generally directed to systems where two or more source driven loads exhibit differences in frequency response characteristics and dynamical behavior corresponding to differences in the load impedances, and is more specifically directed to exploiting these differences through switching method and apparatus to selectively achieve a variety of desired system frequency response characteristics and dynamical behaviors.

### BACKGROUND OF THE INVENTION

Consider a linear, time-invariant, physical dynamical system Z with a time varying input signal u(t) and a time varying output signal y(t):

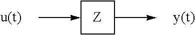

Using the well-known Laplace transform, any such system can be completely characterized by its transfer function Z(s), were s is the usual complex (Laplace) variable, relating the transformed output signal Y(s) to the transformed input signal U(s) through the relation:

Y(s)=Z(s) U(s)

which can be pictorially represented as follows:

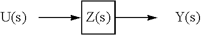

Substituting jω for s, where j is the usual complex number given by the square root of −1 and ω is frequency, yields the so called frequency response of the system, Z(jω), which is usually depicted by plots of its magnitude and phase angle as a function of frequency. These plots provide a graphical representation of the system dynamical behavior as a function of frequency, depicting how the system amplifies (or attenuates) and shifts the phase of input signals as a function of their frequency to produce the output response signal, thereby completely characterizing the dynamical behavior of the system.

In applications, the transfer function Z(s) is usually referred to as the system impedance, and the term impedance is used throughout to refer to the system transfer function. The representation of a physical dynamical system by an impedance is universal, applying to electrical systems, mechanical systems, acoustical systems and all other types of physical systems, as well as hybrid systems involving mixed physical components (e.g. electro-mechanical systems). This representation also applies, in aggregate, to arbitrarily complex (linear, time-invariant) interconnections of such systems, which can always be viewed as some sequence of nested parallel and/or series interconnections of the systems.

For example, a loudspeaker is an electro-mechanical-acoustical system which can be represented by an impedance and corresponding frequency response characteristics. Shown below is a measured frequency response (magnitude vs. frequency) for a commercially available loudspeaker used in guitar amplifiers and speaker cabinets used with guitar amplifiers, showing how the output signal amplitude (sound pressure level) varies as a function of the frequency of the input signal level (applied voltage), for a fixed level (amplitude) input.

The physical system represented by the impedance Z(s) usually has its input signal u(t) generated by a source system which has its own impedance H(s) and input signal x(t):

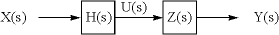

H(s) is sometimes referred to as the output impedance of the source, or source impedance, with x(t) referred to as the source input, and in this case Z(s) is often referred to as the load impedance. As mentioned previously, here Z(s) may represent the aggregate load impedance corresponding to a complex interconnection of multiple components, of either similar of different physical types.

For example, keeping with the loudspeaker example above, H(s) would represent the output impedance of the guitar amplifier driving the speaker, with x(t) the signal applied at the input of the guitar amplifier, u(t) the signal delivered from the guitar amplifier output to the speaker, and y(t) the acoustic output of the speaker. In this case, the speaker or speaker network would typically be referred to as the load driven by the amplifier or source.

Often it is desirable to drive multiple loads with a single source. For example, in the case of guitar amplifiers, often two (or more) speakers are connected to a single amplifier for various reasons, such as power handling capability, desired volume level, etc.

Considering for a moment the simplest (yet most fundamental) case of two load impedances Z₁(s) and Z₂(s) driven by a single source, there are two options for how the two loads can be connected to the source. One option is to connect the loads in series with the source, as is shown in FIG. 21. Another option is to connect the loads in parallel with the source, as is shown in FIG. 22.

In both cases an aggregate impedance Z(s) is formed by the interconnected load impedances, and well-known formulas can of course be used to compute the aggregate impedance Z(s) for each of the series and parallel interconnections.

Now, in the case where the two load impedances are identical, the aggregate parallel and series impedances are simple scalar multiples each other and the individual (identical) load impedances. Consequently, in this special case the parallel, series and individual load impedances all have essentially identical frequency responses and dynamical behavior. Specifically, the frequency response phase curves are all identical, and the frequency response magnitude curves have identical shapes, differing at most by scalar multiples which are constant across all frequencies.

For this reason, in applications the decision to use multiple loads, and whether to connect them in series or parallel with the source, has historically been somewhat arbitrary as regards considerations of frequency response and dynamical behavior, given that, for identical loads, there is no essential difference in the frequency response characteristics or dynamical behaviors of the individual loads, their parallel interconnection or their series interconnection.

For example, the decision to use multiple speakers in guitar amplifiers and speaker cabinets used with guitar amplifiers is typically based on power handling and volume considerations. Further, the speakers are typically “hard-wired” somewhat arbitrarily in either fixed series or parallel interconnections. As the speakers are typically the same brand and model (i.e. apparently identical), there has been no reason to believe that any of these choices impact frequency response or dynamical behavior. Further, even when different brands or models of speakers are used, there has been no reason to prefer one of series or parallel interconnection based on considerations of frequency response or dynamical behavior.

The above notwithstanding, it has first been discovered that even apparently identical loads have impedances that necessarily differ from one another due to manufacturing tolerance variations in the component manufacturing processes and the final assembly process. In addition, different rates of in-service deterioration and aging can also cause differences in the load impedances.

Further, it has also been discovered that when the load impedances are not identical, the aggregate impedances of their series and parallel interconnections are no longer simple scalar multiples of one another, or of either of the individual loads. Thus, the frequency responses and dynamical behaviors of each of the loads, their aggregate parallel interconnection, and their aggregate series interconnection are distinctly different from one another, even when the loads are apparently identical. This discovery is made completely transparent through the related discovery of a “virtual” impedance relating the aggregate impedances of the series and parallel interconnections of the physical load impedances, with the virtual impedance zero only in the (practically unachievable) case of perfectly identical physical load impedances. Specifically, it is shown that the aggregate impedance of the parallel interconnection of the two physical load impedances is equivalent—modulo a simple scalar multiple which does not essentially alter the frequency response or dynamical behavior—to the aggregate impedance of the series interconnection of the two physical load impedances and the virtual load impedance. Thus, the parallel interconnection of the two physical loads can be viewed as having the effect of adding a third “virtual” load impedance to the interconnection network, in series with the series interconnection of the two loads.

Further, it has also been discovered that selectively switching the source between driving two or more of these different load arrangements (i.e. first load, second load, parallel interconnection, series interconnection) provides selective variety in the frequency response characteristics and dynamical behavior of the system so comprised, providing greater system flexibility, utility and/or capability in applications. Here “switching” generally refers to a method and apparatus (abbreviated by “device” in all that follows) for changing the way power flows from the physical power source into the physical loads, through some change in the device parameters or configuration; for example, by changing the position of an electrical switch or switches, and/or changing the arrangement of electrical jacks and plug connectors, in order to change the nature of electrical power flow from the electrical power source into the electrical loads. As such, the notion of “switching” referred to here encompasses all types of physical systems, be they electrical, mechanical, optical, acoustical, etc., or hybrid combinations thereof.

Based on the foregoing, the general object of the present invention is to provide greater flexibility, utility and/or capability in systems comprised of sources and multiple loads through the use of a switching device that allows selective exploitation of all or a subset of the discovered, above-mentioned, differences in frequency responses and dynamical behaviors between the individual loads, their series interconnection, and their parallel interconnection.

For example, in the case of guitar amplifiers and speaker cabinets, the loads correspond to the speakers in the combination amplifier or speaker cabinet. In many cases there are precisely two speakers, and hence two loads. The load impedances are apparently identical, but necessarily different, or purposely different, and today “hard-wired” in one of either series or parallel, with no switching capability. By providing switching capability, much greater variety of capability and tones are realized, with the ability to “switch-on-the-fly” to match a particular need, etc.

Two additional discoveries further enhance the general object of the present invention. First, it has been discovered that the switching device can be reversibly retrofitted to existing fielded systems, providing further utility and enabling additional applications. It has also been discovered that the switching device can be retrofitted to the system wholly within the geometric confines of the existing system, to preclude the possibility of damage to the switching device in handling or transportation of the system (e.g., in guitar combination amplifiers or speaker cabinets).

Finally, it has also been discovered that the loads can be purposefully chosen, to be different—by design—to accentuate and further exploit the above described benefits. In other words, the desired level and character of the differences between the load impedances can be specified by design to accentuate the variations in the resulting frequency response characteristics and dynamical behaviors selectively enabled by the switching device. For example, in the case of guitar amplifiers and speaker cabinets, the differences in the impedance characteristics of the speakers employed can be specified by design—to achieve a prescribed level of difference—to tailor the variations in the resulting frequency response characteristics and dynamical behaviors selectively enabled by the switching device to achieve a desired spectrum of sounds and tones. As another example in this same application, one of the loads may correspond to a “dummy load”, or power resistor, used to dissipate power to reduce volume, or may also correspond to a headphone set or recording equipment, while the other load may correspond to a loudspeaker, corresponding to dramatically different load impedances, which enable one to selectively tailor the guitar amp or speaker cabinet by “switching” to either live performance (loud) or home practice/studio (quiet) use.

Without loss of generality, in all that follows, we explicitly consider only the case of precisely two source-driven loads. Indeed, for the case of more than two loads, related extensions immediately follow from the two load case for anyone skilled in the art, as an arbitrary interconnection of an arbitrary number of distinct loads can always be described as a nested sequence of interconnections of two (possibly aggregate) loads in either series or parallel. As such, extensions immediately follow from the two load case, and only this case need be specifically addressed in what follows.

### SUMMARY OF THE INVENTION

To summarize the invention, we start with the well-known formulas for the series and parallel interconnection of two loads, corresponding to Figures A and B, respectively:

$$\begin{matrix}{Z}_{s} = {Z}_{1} + {Z}_{2} & 1 ) \\ {Z}_{p} = \frac{{Z}_{1} * {Z}_{2}}{{Z}_{1} + {Z}_{2}} & 2 )\end{matrix}$$

In the case where the impedances are identical:

Z₁=Z₂=Z 3)

For this idealized case, substitution of 3) into 1) and 2) yields, respectively:

Zₛ=2Z 4)

Zₚ=Z/2 5)

For this idealized case, it therefore follows that:

Zₛ=4Zₚ 6)

From 4)-6) we see that, for identical load impedances, the impedances of the loads, their aggregate series interconnection, and their aggregate parallel interconnection are all simple scalar multiples of one another. The implication is that there is no essential difference in the dynamic responses of the loads, their parallel interconnection or their series interconnection, i.e. the frequency response phase curves are all identical, and the frequency response magnitude curves are identical in shape, differing only by a fixed scalar multiple which is constant across all frequencies.

For this reason, the decision to use multiple loads, and whether to connect them in series or parallel with the source, has historically been somewhat arbitrary as regards considerations of frequency response and dynamical behavior, given that, for identical loads, there is no essential difference in the frequency responses or dynamical behaviors.

For example, the decision to use multiple speakers in guitar amplifiers and speaker cabinets used with guitar amplifiers is typically based on power handling and volume considerations. Further, the speakers are typically “hard-wired” somewhat arbitrarily in either fixed series or parallel interconnections. As the speakers are typically the same brand and model (i.e. apparently identical), there has been no reason to believe that any of these choices impact dynamical behavior or frequency response. Further, even when different brands and/or models of speakers are used, there has been no reason to prefer one of series or parallel interconnection based on considerations of frequency response and dynamical behavior.

The above notwithstanding, it has been discovered that even apparently identical loads have impedances that necessarily differ from one another due to manufacturing tolerance variations in the component manufacturing processes and the final assembly process. In addition, different rates of in-service deterioration and aging can also cause differences in the load impedances. This discovery is universal, applying across all types of apparently identical loads. For example, in guitar amplifiers and speaker cabinets used with guitar amplifiers, even in the case of identical make/model speakers, the frequency response characteristics of the speakers will differ, corresponding to differences in dynamical behavior and impedance.

Of course, the impedances of the loads may also differ intentionally in some applications. For example, in guitar amplifiers and speaker cabinets used with guitar amplifiers, sometimes different make/model speakers are used for certain reasons, such as having the characteristics of one speaker compliment those of the other in a “hard-wired” arrangement; for example, to achieve a “choir” like effect. Further, in this example, one of the loads may correspond to a “dummy load”, or power resistor, used to dissipate power to reduce volume, or may also correspond to a headphone set or recording equipment, while the other load may correspond to a loudspeaker, corresponding to dramatically different load impedances.

Whether unintentional or intentional, the difference in load impedances can be exploited through a switching device to obtain great variety in frequency response and dynamical behavior. To fully develop this idea, we now return to the mathematics to consider the case of non-identical load impedances. To analyze the case where the load impedances are not identical we first define the difference in the two load impedances:

Z_{Δ}=Z₂−Z₁ 7)

### Solving equations 1) and 7) for Z₂ and Z₁ as functions of Z_{Δ} and Zₛ yields:

$$\begin{matrix}{Z}_{2} = \frac{{Z}_{s} + {Z}_{Δ}}{2} & 8 ) \\ {Z}_{1} = \frac{{Z}_{s} - {Z}_{Δ}}{2} & 9 )\end{matrix}$$

Substituting 8) and 9) into 2) yields the following expression:

$${Z}_{p} = \frac{{Z}_{s}^{2} - {Z}_{Δ}^{2}}{4 {Z}_{s}} \qquad 10 )$$

Rearranging 10) yields:

$${Z}_{s} - \frac{{Z}_{Δ}^{2}}{{Z}_{s}} = 4 {Z}_{p} \qquad 11 )$$

Defining now the virtual impedance as:

$${Z}_{v} = \frac{- {Z}_{Δ}^{2}}{{Z}_{s}} \qquad 12 )$$

We can recast 11) as:

Zₛ+Zᵥ=4Zₚ 13)

Note the striking similarity of 13) to 6). Note also that 13) yields 6) only when Zᵥ=0, which is only achieved when Z_{Δ}=0, corresponding to the idealized, practically unachievable case of perfectly identical loads. When the loads are not identical, Zᵥ is not zero, and the aggregate parallel and series impedances are no longer simple scalar multiples of either each other or the individual load impedances. Hence, in the case of non-identical loads, the individual loads, their parallel interconnection and their series interconnection exhibit distinctly different frequency responses and dynamical behaviors.

Referring to 1), we see that the left-hand side of 13) can be interpreted as the aggregate impedance of the series interconnection of the virtual impedance with the aggregate series impedance of the two physical loads. Accordingly, we can represent the left-hand side of 13) by the diagram shown in FIG. 23. Now, the right-hand side of 13) involves the parallel impedance of the two physical loads, which can be depicted as shown in FIG. 24.

Recognizing that the fixed scalar multiple of four in 13) doesn't alter the essential character of the frequency response or dynamical behavior of the right-hand side of 13), we can interpret 13) as saying that the frequency responses and dynamical behaviors of the aggregate impedances represented in Figures C and D above are essentially identical. In effect, the parallel interconnection of the two physical loads is equivalent to adding a third “virtual” load—in series—to the series interconnection of the two physical loads, and this third “virtual” load is zero only in the practically unachievable case where the two physical loads are identical. Thus, the virtual impedance makes clear the essential difference in character between the frequency responses and dynamical behaviors of the individual physical loads, their parallel interconnection, and their series interconnection, in the practically ever-present case of non-identical physical loads.

The discovery and development of the virtual impedance makes clear that switching the source between driving one load, the other (necessarily different) load, both loads in series, or both loads in parallel, or some subset thereof, will result in different system frequency responses and dynamical behaviors. A system augmented with such a switching device can thus be selectively switched (e.g., by its user) between frequency responses and dynamical behaviors to tailor its operation to a given situation, providing much greater flexibility, utility and/or capability to the system. Clearly, a switching device that switches only between even any two of the four modes described above will provide greater flexibility, utility and/or capability to the system. It is also clear to one skilled in the art that this analysis and approach can be readily extended to encompass the situation of more than two physical loads (possibly also involving multiple sources), since the interconnection of the multiple physical loads can be viewed as a sequence of nested parallel and/or series interconnections of two (aggregate) loads.

The discovery and characterization of the impedance differences inherent in apparently identical loads, the related discovery and characterization of virtual impedance, and the related discovery of the utility of switching devices can be exploited in many different ways across many classes of physical systems in a wide range of applications.

In what follows, we will describe only those embodiments of the present invention involving two distinct (possibly aggregate) physical loads. However, the invention is not limited in this regard, as extensions to the case of more than two (aggregate) loads and switching between them and or different combinations of nested parallel and/or series interconnections of them will be obvious to one skilled in the art.

One preferred embodiment of the present invention enables switching between all four of the modes previously described (load 1 alone, load 2 alone, both loads in parallel, both loads in series). We will describe not only this embodiment, but also other embodiments that switch between only a subset of these four modes; specifically, between only two and also three of the modes. However, the invention is not limited to the embodiments thus described, as other related embodiments will be obvious to one skilled in the art.

The embodiments of the switching device of the present invention described in what follows are all electrical switching devices, such as would be used for switching an electrical power source between electrical loads, such as loudspeakers. However, the invention is not limited in this regard, as extensions to mechanical (for mechanical power sources driving mechanical loads) and many other, possibly hybrid, different physical types of power switching devices will be obvious to one skilled in the art.

Also, we only describe passive, non-reactive embodiments of the switching device of the present invention in what follows. However, the invention is not limited in this regard, as extensions to active and/or reactive embodiments will be obvious to one skilled in the art.

Throughout, it is understood that the loads under consideration may be apparently identical or purposefully different. In the case of purposefully different loads, the desired level and character of the differences between the load impedances can be specified by design to accentuate the variations in the resulting frequency response characteristics and dynamical behaviors selectively enabled by the switching device of the present invention. For example, in the case of guitar amplifiers and speaker cabinets, one of the loads may correspond to a “dummy load”, or power resistor, used to dissipate power to reduce volume, or may also correspond to a headphone set or recording equipment, while the other load may correspond to a loudspeaker, corresponding to dramatically different load impedances.

Further, it is recognized that the load impedances considered may each be the aggregate impedance of arbitrarily complex networks of interconnected impedances of similar or vastly different types, providing further utility in applying the invention.

Preferred embodiments of the switching device of the present invention, as will be explained in detail below, can be retrofitted easily to many devices and include connection means for coupling a first and a second load to the switching device. The first and second loads cooperatively define a virtual impedance as described above. Coupling means define connection points for selectively accepting an output from at least one power source (signal generator), such as, but not limited to, an amplifier. The coupling means are in communication with the connection means. In these preferred embodiments, a switch is in electrical communication with the connection means as well as with the coupling means. Depending on the type and position of the switch and the configuration of the switching device, the first and second loads can be individually operable, or simultaneously operable in stereo with a different source driving each, or simultaneously operable in either parallel interconnection or series interconnection, with one source driving both loads. Depending on the type of the switch and the configuration of the switching device, all or some subset of these different operating modes are selectable depending on the switch position. Using the switching capability provided by the switching device, the desired mode of operation—and hence frequency response and dynamical behavior—can be selected as needed, at any particular time, to meet the needs of a particular situation, providing the system equipped with the switching device more flexible capabilities and utility in applications. For a fixed switch setting and configuration of the switching device, the loads can then be operated in the selected configuration to generate a predetermined output. Preferably, signals are provided that are receivable by the first and/or second loads, the signals being indicative of the predetermined output.

The present invention further resides in mounting means for releasably mounting embodiments of the above-described switching device to a structure, such as, for example, a guitar amplifier speaker cabinet or a so-called combination amplifier (wherein the amplifier and speakers are all contained within the same cabinet). Preferably, the clamping means includes three extensions projecting outwardly from the base plate, but the invention is not limited in this regard. Two of the extensions are substantially coplanar with the third of the extensions being offset relative to the coplanar extensions and positioned there between. The three extensions can be positioned over and straddle a rail forming part of the cabinet. A fastener threadably extends through the third extension and defines an end engageable with the rail to releasably retain the switching device thereon. In another embodiment, where the switching device is mounted in an aperture defined by the cabinet, the base plate is configured such that it defines a mounting flange extending around and projecting outwardly from a periphery thereof. When the switching device is positioned in the aperture, the flange extends over and covers the peripheral edges that define the aperture.

In this manner, the preferred embodiments of the present invention are retrofittable to virtually any structure and are particularly retrofittable to guitar speaker cabinets and combination amplifiers. In addition, the retrofitting of a device in the above described manner is completely reversible so that if desired, a system to which it has been mounted to can be restored back to its original state. Further, since the device does not protrude in any way outside the confines of the cabinet or structure, it is not exposed to the risk of handling damage in transporting the system, etc.

In another embodiment of the present invention, the switching device includes a base plate. Connection means are included for releasably coupling at least one load (e.g., with high power handling capability, such as a guitar speaker network) to the base plate and at least two jacks are coupled to the base plate for releasably attaching a source (e.g. guitar amplifier) and at least one load (e.g., low power handling capability, such as a pair of headphones or recording equipment) to the switching device. The at least two jacks are in (electrical) communication with the connection means. A dummy load (e.g., in the form of at least one power resistor) is coupled to the base plate and in (electrical) communication with the connection means and base-plate mounted load jack for absorbing power from the source releasably coupled to the switching device. Preferably, a switch is coupled to the base plate and in communication with the jacks and the connection means. The switch is movable to a first position so that when the source is releasably coupled to one of the at least two jacks, and a load (e.g., headphones or recording equipment) releasably coupled to the other of the at least two jacks, the source (e.g., amplifier) powers the load (e.g., headphones or recording equipment) with a portion of the power being supplied by the source (e.g., amplifier) being absorbed by the dummy load. The switch is movable to a second position wherein the source (e.g., amplifier) coupled to one of the jacks powers a load (e.g. speaker) coupled to the connection means.

### BRIEF DESCRIPTION OF THE DRAWINGS

FIG. 1 is a perspective view of an embodiment of the switching device of the present invention.

FIG. 2a is a top view of a combination amplifier having the switching device of FIG. 1 mounted thereon.

FIG. 2b is a rear view of a combination amplifier having the switching device of FIG. 1 mounted thereon.

FIG. 2c is a cross-sectional side view of a combination amplifier having the switching device of FIG. 1 mounted thereon.

FIG. 3a is a perspective view of a mounting bracket forming part of the switching device of FIG. 1.

FIG. 3b is a side view of the mounting bracket of FIG. 3.

FIG. 3c is a front view of the mounting bracket of FIG. 3.

FIG. 4 is a side view of the mounting bracket of FIGS. 3a-c showing a clamping fastener threadably engaged therewith.

FIG. 5 schematically illustrates the manner in which the switching device of FIG. 1 can be wired.

FIG. 6 is a schematic block-diagram representation of the switching device of FIG. 1 illustrating the interaction of the switching device with a combination amplifier and speaker cabinet.

FIG. 7 is an electrical schematic of the switching device of FIG. 1.

FIG. 8 is an electrical schematic of an alternate embodiment of the switching device of FIG. 1.

FIG. 9 is an electrical schematic of an alternate embodiment of the switching device of FIG. 1.

FIG. 10 is an electrical schematic of an alternate embodiment of the switching device of FIG. 1.

FIG. 11 is an electrical schematic of an alternate embodiment of the switching device of FIG. 1.

FIG. 12 is an electrical schematic of an alternate embodiment of the switching device of FIG. 1.

FIG. 13 is a front view of an alternate embodiment of the base plate forming part of the switching device of the present invention.

FIG. 14 is a side view of the base plate of FIG. 13.

FIG. 15a is a rear view of a speaker cabinet having the base plate of FIG. 13 mounted thereon.

FIG. 15b is a side view of a speaker cabinet having the base plate of FIG. 13 mounted thereon.

FIG. 16 is a perspective view of an alternate embodiment of the switching device of the present invention.

FIG. 17 is a schematic block-diagram representation of the switching device of FIG. 16 illustrating the interaction of the switching device with a combination amplifier and speaker cabinet.

FIG. 18 schematically illustrates the manner in which the switching device of FIG. 9 can be wired.

FIG. 19 is an electrical schematic of the switching device of FIG. 16.

FIG. 20 is an electrical schematic of an alternate embodiment of the switching device of FIG. 16.

FIG. 21 schematically illustrates two load impedances connected in series with a single source.

FIG. 22 schematically illustrates two load impedances connected in parallel with a single source.

FIG. 23 schematically illustrates an aggregate impedance of a series interconnection of virtual impedance with an aggregate series impedance of two physical loads.

FIG. 24 schematically illustrates a parallel impedance of two physical loads.

### DETAILED DESCRIPTION OF THE PREFERRED EMBODIMENTS

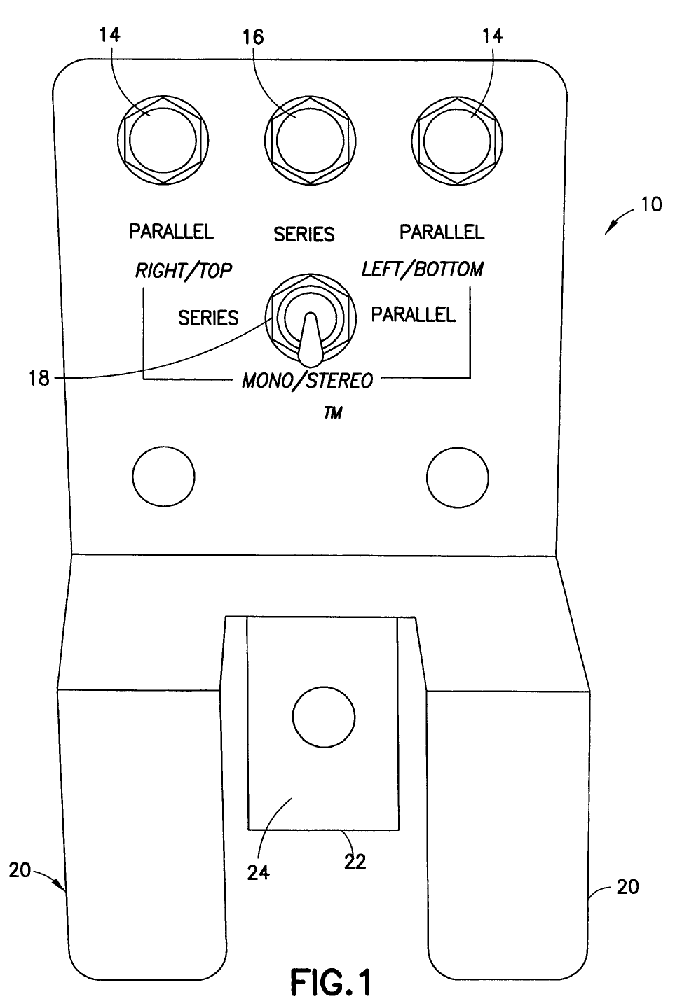

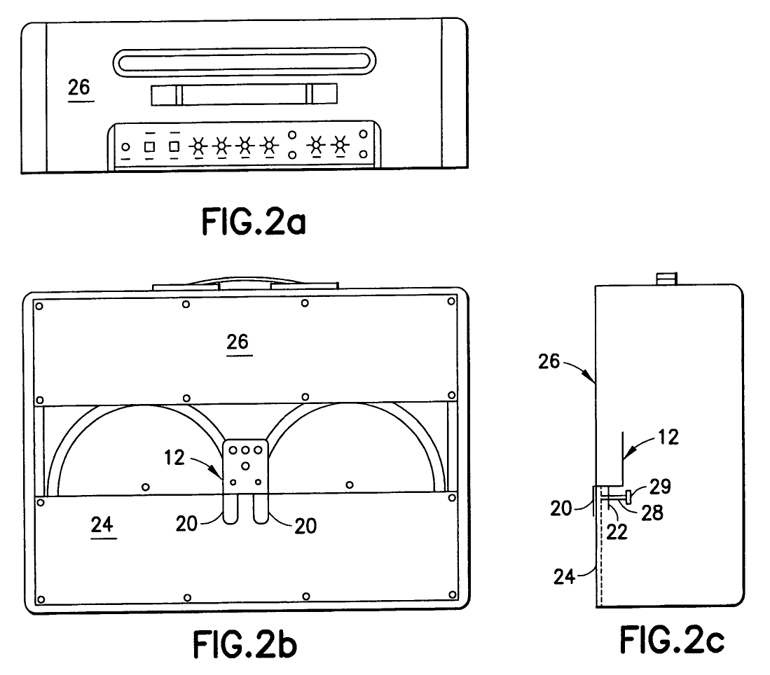

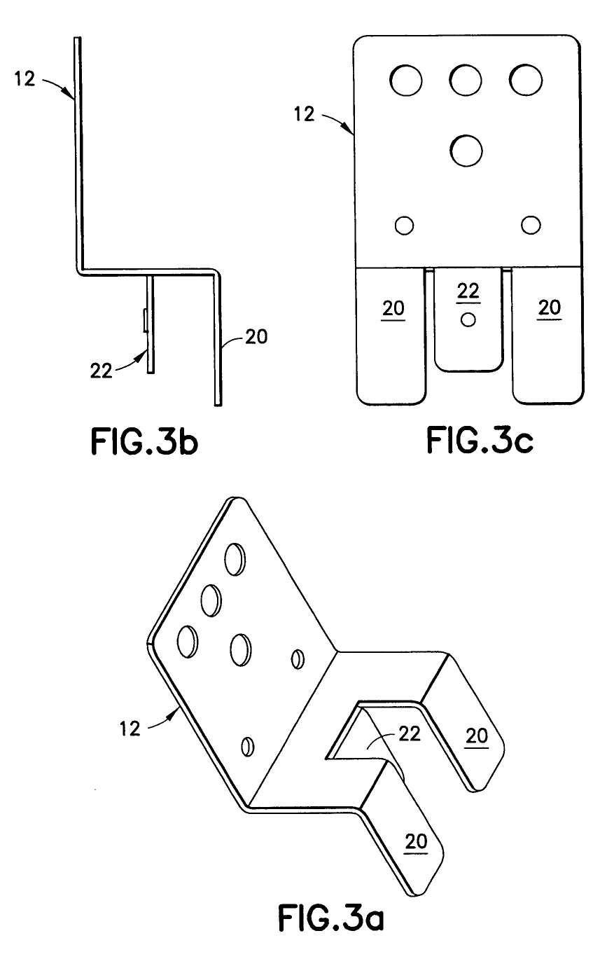

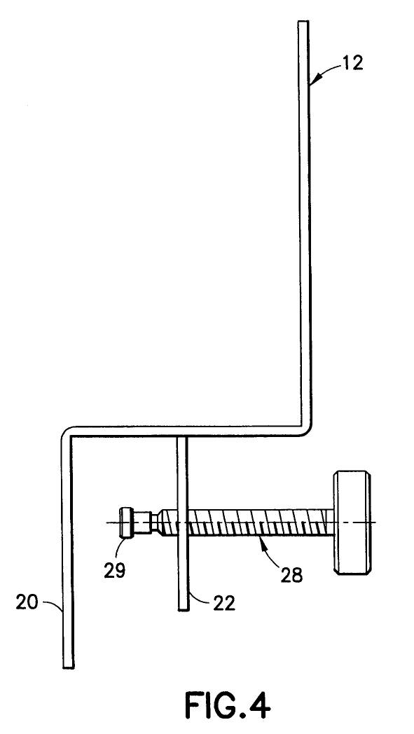

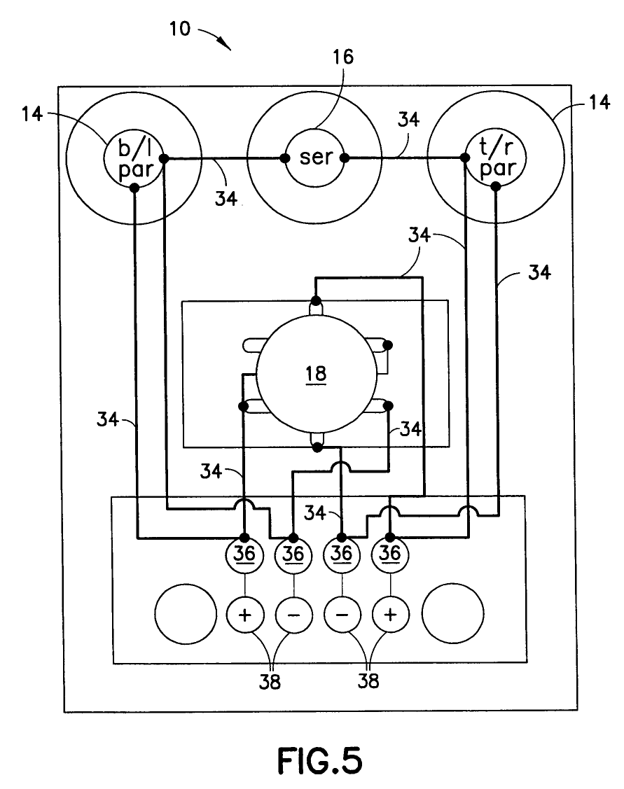

As shown in FIG. 1, and schematically illustrated in FIGS. 5-7, an embodiment of the switching device of the present invention is generally designated by the reference number 10 and includes a base plate 12 having three jacks mounted thereto. As will be explained in greater detail below, in one mode of operation, the outermost two jacks 14 are for parallel connections, and the central jack 16 is for series connections. A multi-position switch 18 is also mounted to the base plate 12 and as will also be explained in detail below, is in electrical communication with the three jacks, 14, 14, and 16. In the illustrated embodiment, and as further seen in FIGS. 3a-c and FIG. 4, the base plate 12 includes three extensions projecting outwardly therefrom, two of the extensions 20 are substantially coplanar with one another. The third extension 22 is offset relative to the coplanar extensions 20 and is positioned there between. The three extensions 20, 20, and 22 allow the switching device 10 to be positioned over and straddle a rail 24 forming part of a speaker cabinet or combination amplifier 26, FIGS. 2a-c. As best seen in FIG. 4, a fastener 28 threadably extends through the third extension 22 and defines an end 29 engageable with the rail 24, of the speaker cabinet 26, to releasably and clampingly retain the switching device 10 thereon. This mounting arrangement allows the switching device 10 to be retrofittable to most speaker cabinets. Once retrofitted, the switching device 10 can be removed from the speaker cabinet easily, thereby making the retrofitting process completely reversible. This arrangement has the further advantage of positioning the device fully within the cabinet to avoid handling and/or transportation damage, etc. While the baseplate has been shown and described as including three extensions, the present invention is not limited in this regard as all that is required is that the base plate form a pocket into which the rail is slidably receivable. Accordingly, the base plate could consist of a pair of extensions offset relative to one another, without departing from the broader aspects of the present invention.

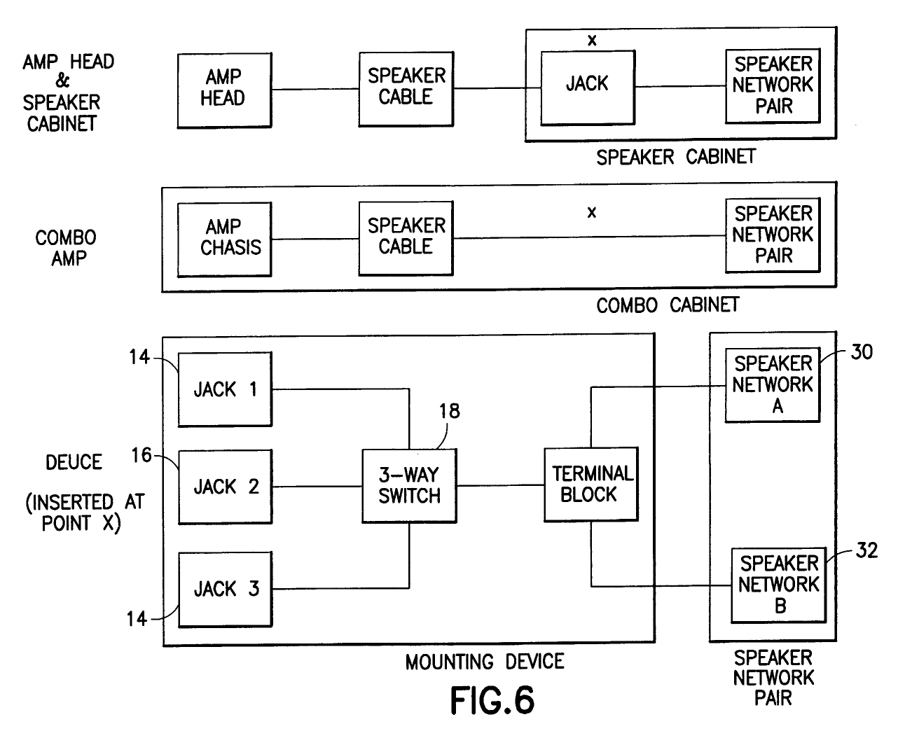

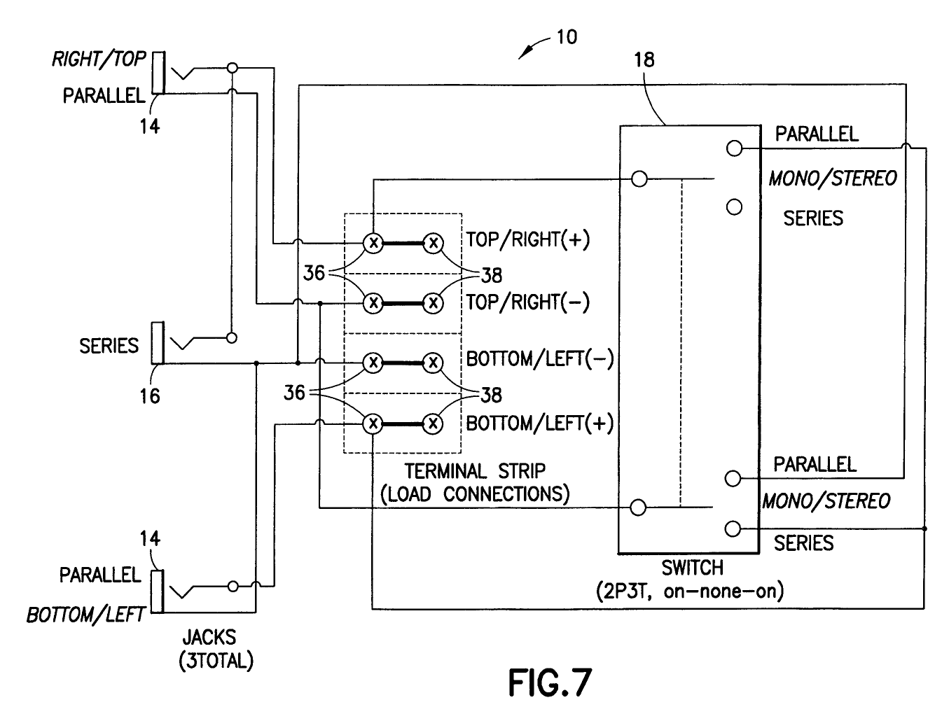

As shown in FIGS. 5, 6, and 7 the switching device 10 is configured so that two loads 30 and 32, shown in FIG. 6 as speakers, can be connected to an amplifier (not shown) via one of the jacks, 14, 14 and 16 and depending on the position of the switch 18 be electrically interconnected in either parallel or series, or operated individually in mono or stereo. Referring specifically to FIG. 5, the multi-position switch 18 is shown as a three-position switch. The switch 18 is electrically connected to the jacks 14 and 16 via conductors or wires 34. The switch 18 and the jacks 14 and 16 are also electrically coupled via conductors 34 to connectors 36. While not shown in FIG. 5, the speaker transducers 30 and 32 are coupled via conductors or wires to connectors 38. In the illustrated embodiment, the connectors 36 and 38 are in the form of a four position terminal strip 39, FIG. 7, comprising four pairs of connectors, each pair consisting of one connector 36 and another connector 38. However, the present invention is not limited in this regard as other types of connectors known to those skilled in the pertinent art to which the present invention pertains may be substituted without departing from the broader aspects of the present invention.

Depending on the position of the switch 18 and which jack, 14, 16 an amplifier is releasably connected to, the speakers 30, 32 will behave as though they are interconnected in either series or parallel, or operable individually in either mono or stereo modes. For, example, in the illustrated embodiment, the switch 18 is movable between a first position, a central position, and a second position. When an amplifier is releasably coupled to either of the jacks 14, 14 with the switching device electrically configured as shown in FIGS. 5 and 7, and the switch is in the first position, the speakers 30 and 32 will be connected in parallel with one another. When the amplifier is releasably coupled to the series jack 16, and the switch is in the second position, the speakers 30 and 32 will be connected in series with one another.

In the illustrated embodiment configured as described above, if the switching device 10 is releasably coupled to a two speaker cabinet with the two speakers coupled via the connectors 38 to the switching device, when the switch 18 is in the central position and an amplifier is releasably coupled to one of the parallel jacks 14, only one of the speakers will be operable (mono mode). If a second amplifier is coupled to the other of said parallel jacks 14, then the other of the two speakers will be operable independently of the first speaker (stereo mode).

While the illustrated embodiment has been shown and described as being configured so that the two outermost jacks 14, 14 correspond to parallel connections and the central jack 16 corresponds to a series connection, the present invention is not limited in this regard as the manner in which the switching device is wired can be changed so that any jack can be wired to correspond to either a series or parallel connection when the switch 18 is appropriately positioned.

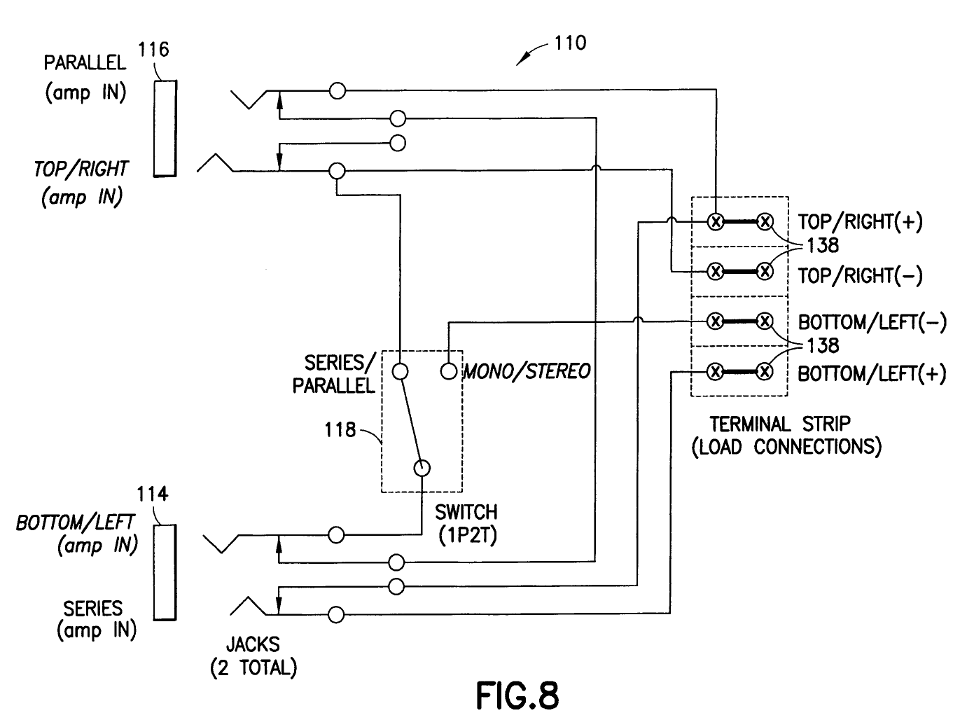

An alternate embodiment of the switching device of the present invention is schematically illustrated in FIG. 8 and is generally designated by the reference number 110. The switching device 110 is similar in many respects to the switching device 10 and therefore like elements are given like reference numbers preceded by the numeral 1. The switching device 110 differs from the switching device 10 in that the switch 118 is a two position switch. In addition, there is a single series jack 114 and a single parallel jack 116. Accordingly, with the switch in the position shown in FIG. 8, coupling an amplifier to one of the two jacks 114, 116 will cause the loads coupled to the connectors 138 to operate in series and parallel respectively. Moving the switch 118 to the other position and coupling an amplifier or other signal generator to jack 114 will cause one of the loads coupled to the terminal strip 138 to be operable. Moving the signal generator to the other jack 116 will cause the other of the loads coupled to the connectors 138 to be operable. Running different signal generators into each jack will cause each of the two loads to operate independently (stereo mode).

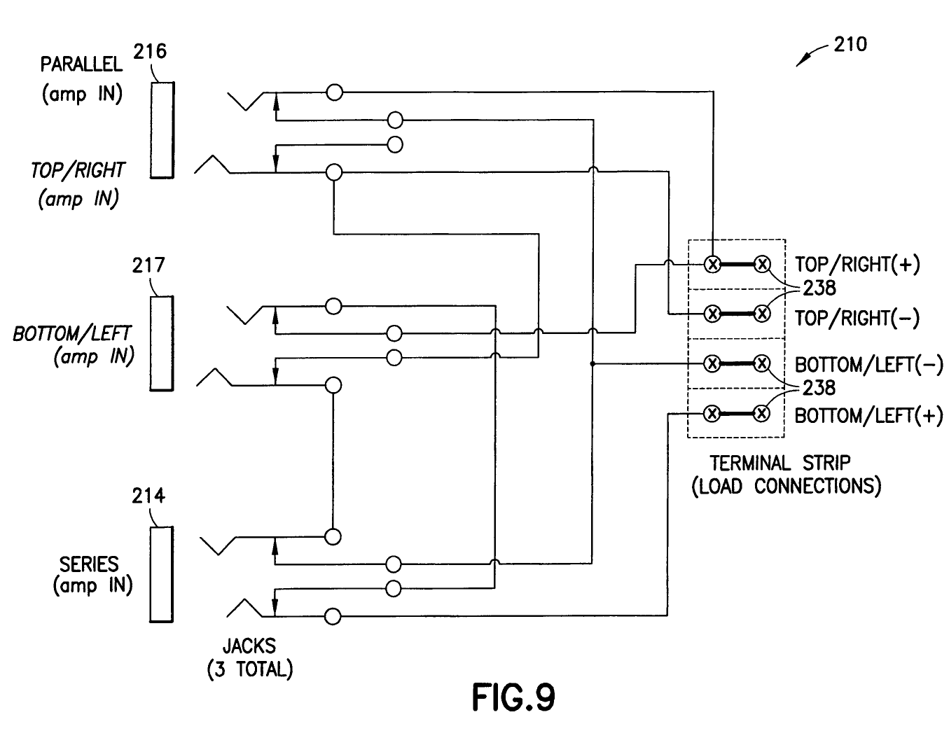

Another embodiment of the switching device of the present invention is schematically illustrated in FIG. 9 and is generally designated by the reference number 210. The switching device 210 is similar to the switching device 10 and 110 with like elements being given like part numbers preceded by the reference number 2. The switching device 210 differs from the switching device 10 and 110 in that there is no switch. Accordingly, connecting an amplifier to the jack 214 will cause the loads coupled to the connectors 238 to be interconnected in series. Similarly, connecting an amplifier to the jack 216 will cause the loads coupled to the connectors 238 to be interconnected in parallel. By inserting a plug into the jack 217, a mono/stereo mode is activated whereby one of the loads coupled to the connectors 238 is individually operable. With a plug coupled to the jack 217, making an amplifier connection to the jack 216 causes the other load to operate. Making connections of two different amplifiers to the jacks 216 and 217 causes both of the loads to operate independently in a stereo configuration.

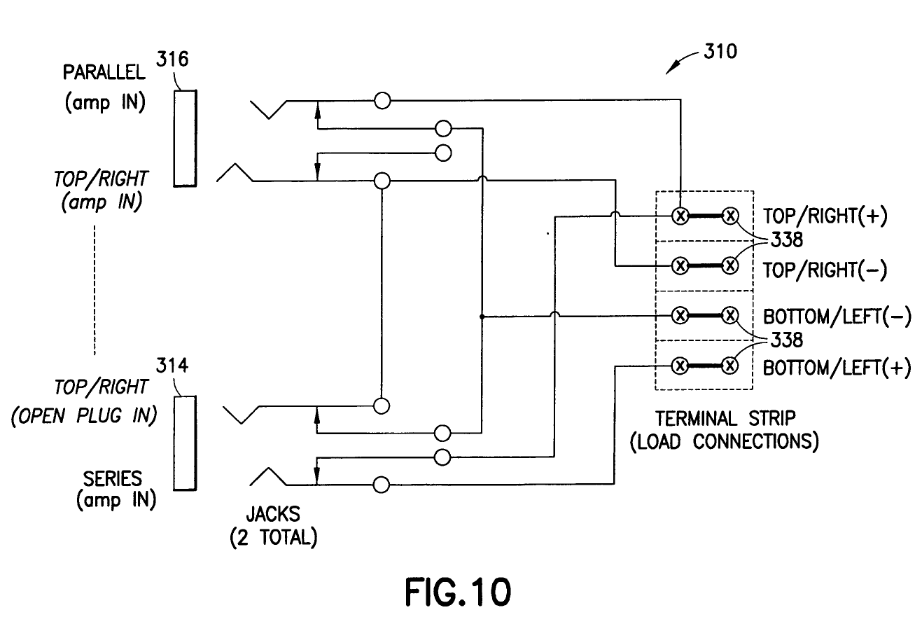

Still another embodiment of the switching device of the present invention is schematically illustrated in FIG. 10 and is generally designated by the reference number 310. The switching device 310 is similar to the switching device 10 with like elements being given like part numbers preceded by the reference number 3. In the illustrated embodiment, there are two jacks 314 and 316 corresponding to series and parallel interconnections respectively. Accordingly, when an amplifier or like device is attached to jack 314, the loads coupled to the connectors 338 are interconnected in series. Similarly, when an amplifier is coupled to jack 316, the loads coupled to the connectors 338 are interconnected in parallel. Moreover, when an open plug is inserted into the series jack 314, an amplifier coupled to jack 316 will cause only one of the loads coupled to the connectors 338 to be operable.

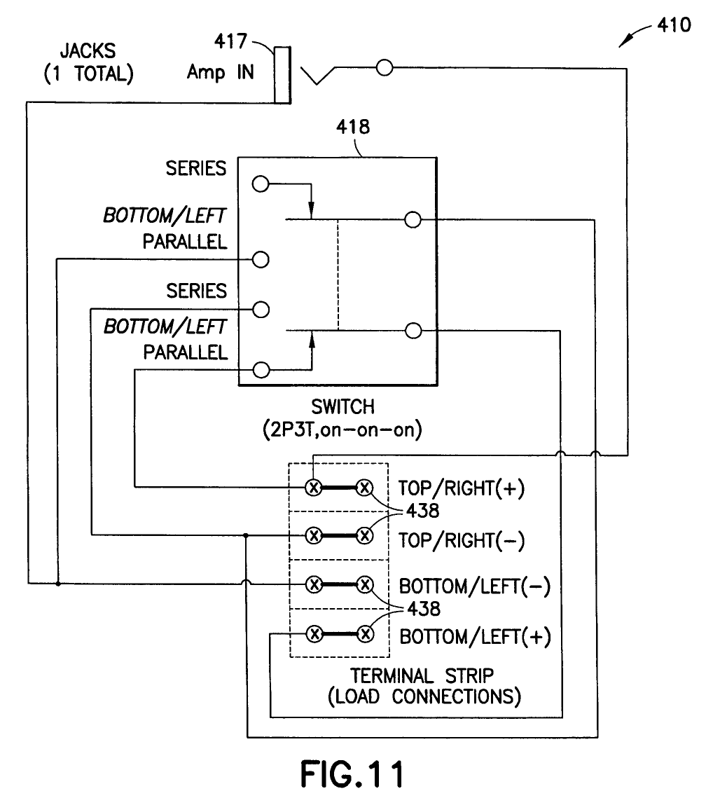

Still another embodiment of the switching device of the present invention is schematically illustrated in FIG. 11 and is generally designated by the reference number 410. The switching device 410 is similar to the switching device 10 with like elements being given like part numbers preceded by the reference number 4. In this embodiment, a double pole, triple throw switch 418 is provided. When an amplifier is coupled to the jack 417, depending on the position of the switch 418, the loads coupled to the connectors 438 will be interconnected in series, parallel, or only a single load will be energized.

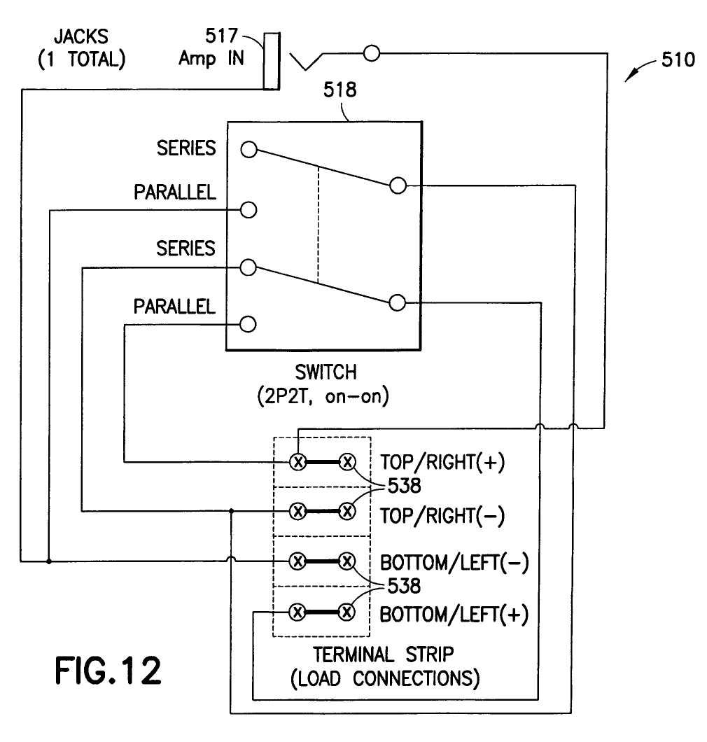

Referring to FIG. 12, another embodiment of the present invention is generally designated by the reference number 510. The switching device 510 is similar to the switching device 10 with like elements being given like part numbers preceded by the reference number 5. In this embodiment, a double pole, double throw switch 518 is provided. In this configuration, when an amplifier is coupled to jack 517, depending on the position of the switch 518, the loads coupled to the connectors 538 are interconnected in either series or parallel.

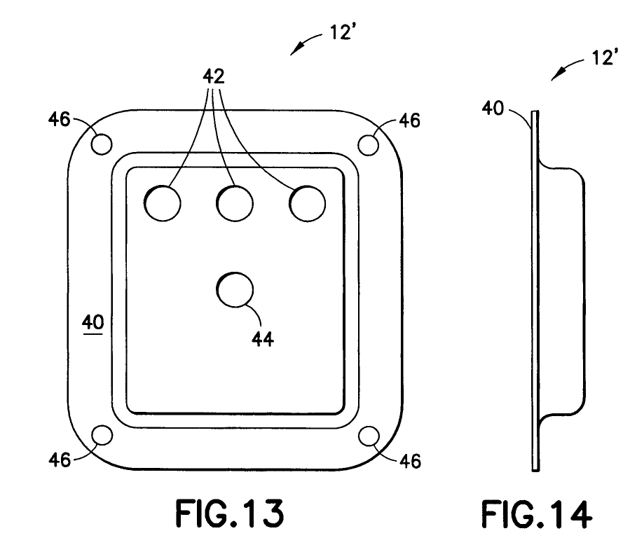

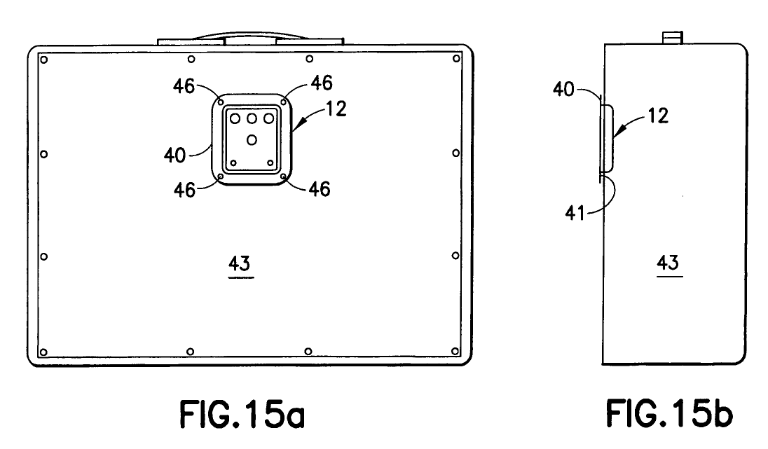

While the illustrated embodiments of the switching device have been shown and described as being mountable to a rail in an opening defined by a speaker cabinet, the present invention is not limited in this regard. As shown in FIGS. 13-16, the base plate 12 can also include a mounting flange 40 extending around and projecting outwardly from a periphery of the base plate. When the switching device 10 employing the base plate 12 is positioned in an opening 41 located in a cabinet 43, the mounting flange 40 extends over and covers the peripheral edges of the opening. A plurality of apertures 46 are defined by the flange 40, each for slidably receiving a portion of a fastener (not shown) used to attach the base plate 12 and thereby the switching device 10 to the cabinet. As shown in FIG. 13, apertures 42 and 44 defined by the base plate 12 are for mounting the jacks 14, 16 and the switch 18 to the base plate.

While the base plate 12 has been described as including apertures adapted to receive fasteners, such as screws, the present invention is not limited in this regard. The switching device 10 can be mounted to the cabinet via other suitable means such as adhesives or hook-and-loop fasteners without departing from the broader aspects of the present invention. In any case, all the wiring and components are wholly contained within the cabinet, protecting them from handling and/or transportation damage, etc.

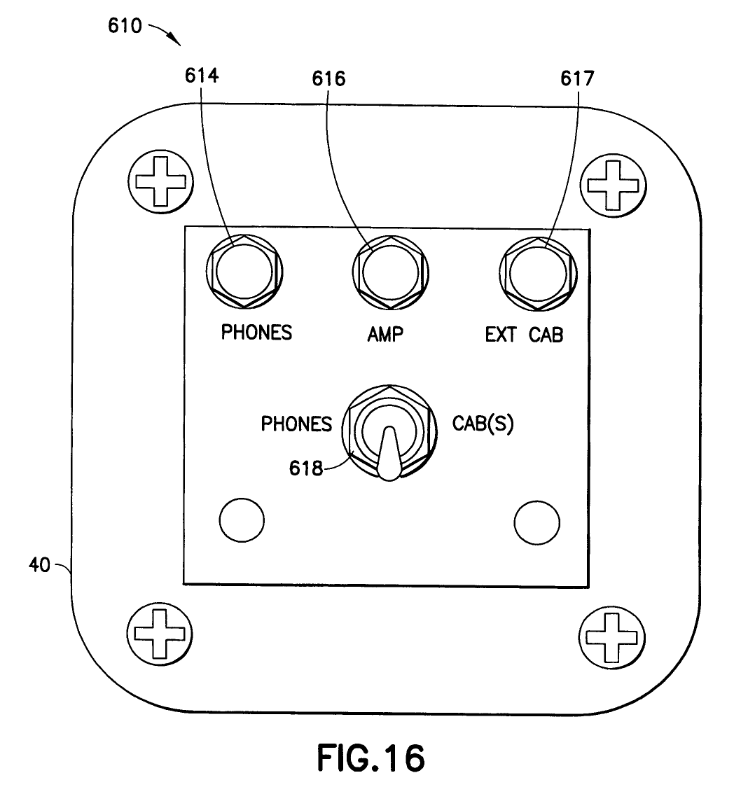

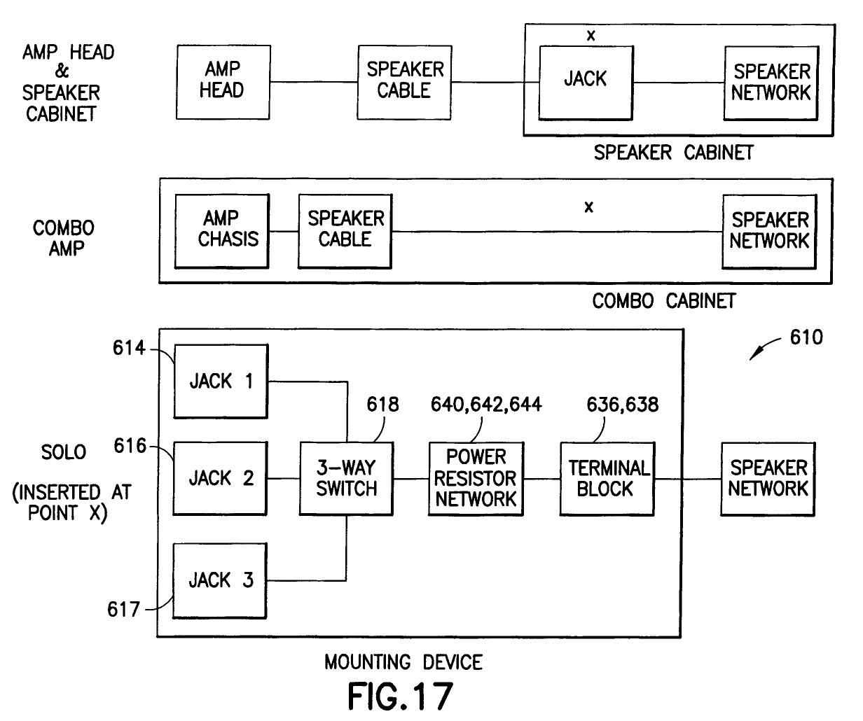

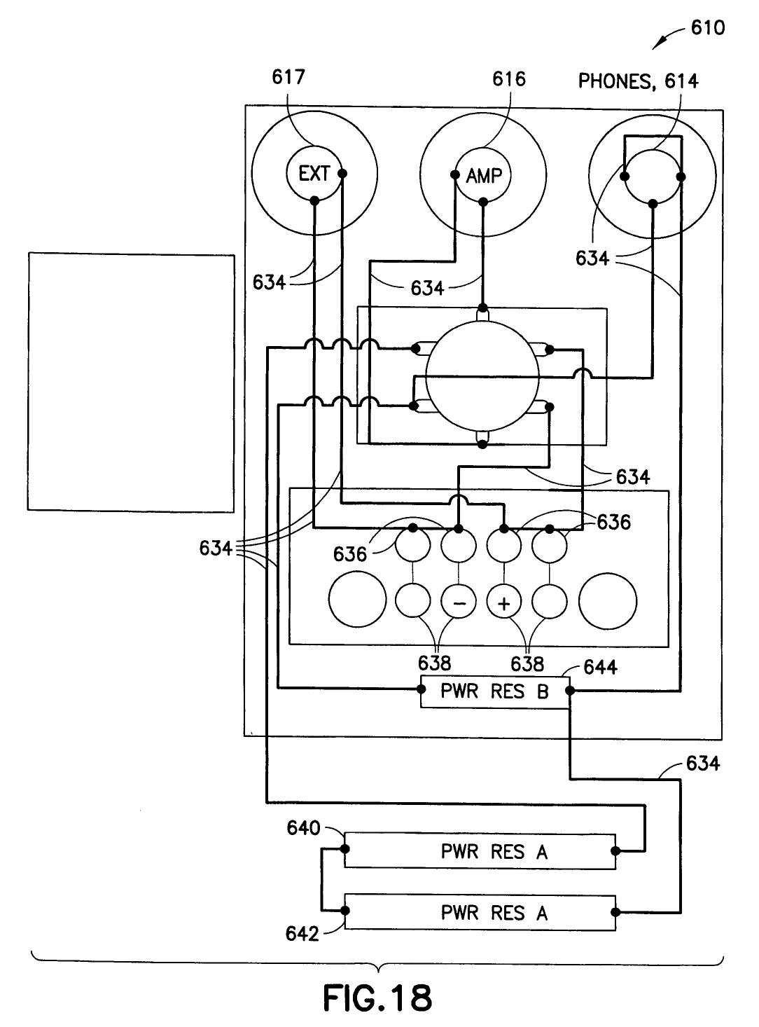

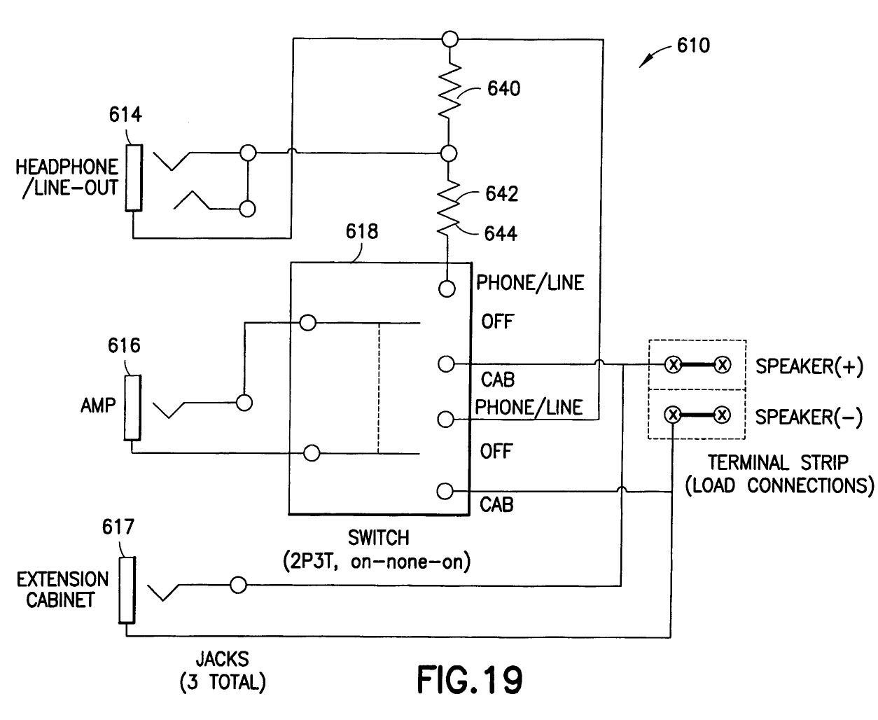

As shown in FIGS. 16 through 19 an embodiment of the switching device of the present invention, generally designated by the reference number 610, can be configured for use with headphones and/or recording equipment. In this embodiment, many of the same components as used with the switching device 10 are used with the switching device 610. Accordingly, the same reference numbers will be used preceded by the number 6 for like elements.

Referring to FIG. 16, the switching device 610 is shown having three jacks 614, 616 and 617 and a three position switch 618. The switching device 610 is configured so that an amplifier, headphones/recording equipment and/or an external cabinet can be releasably coupled thereto via the jacks 614, 616, and 617. The jacks 614, 616 and 617 are in electrical communication via suitable conductors, such as wires 634, with the switch 618, which in the illustrated embodiment is a three position switch. The switch 618 and connectors 638 are also in electrical communication via conductors 634 with connectors 636. In addition, the switch 618, the jacks 614, 616 and 617 as well as the connectors 636 are in electrical communication with a voltage divider formed by power resistors 640, 642 and 644. The power resistors 640 and 642 are electrically coupled together in series to form one half of the voltage divider while the other half of the voltage divider is formed by the power resistor 644.

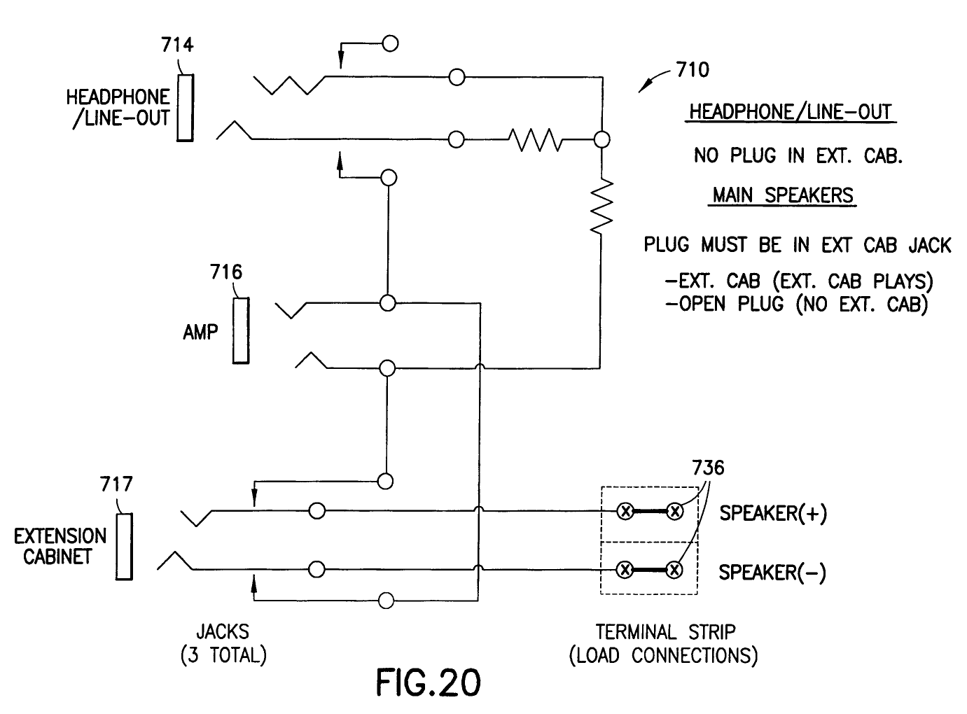

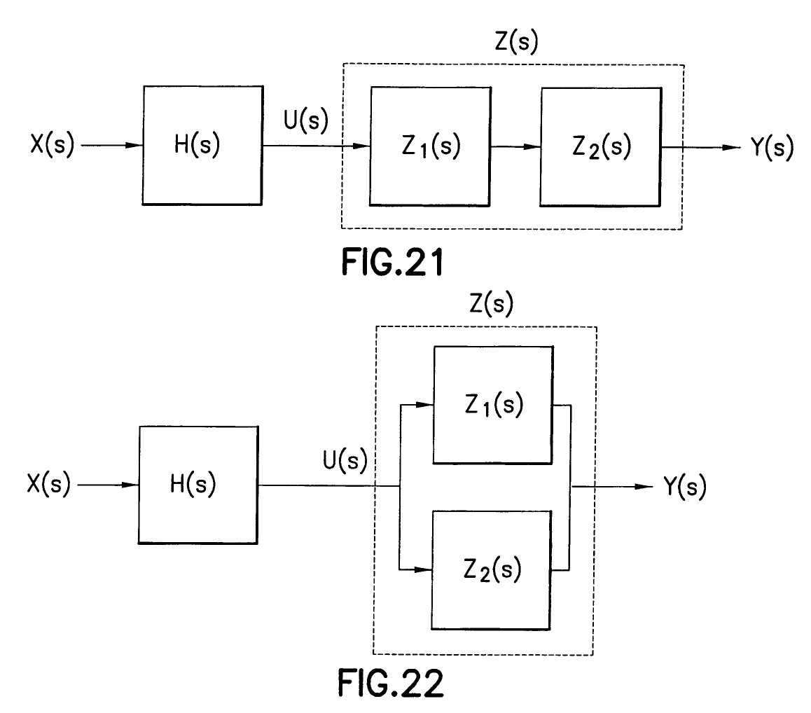

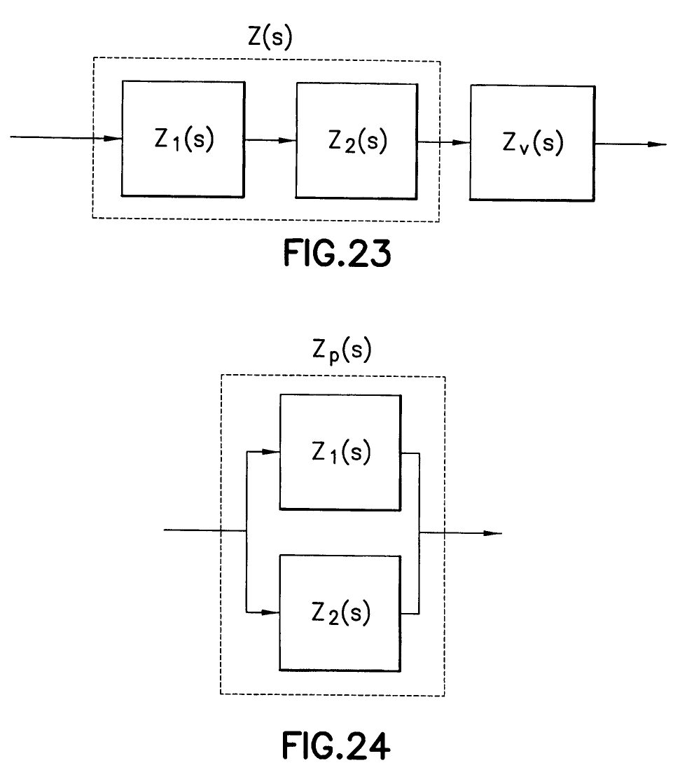

During operation, the switch 618 is movable to a first position so that when an amplifier is releasably coupled to jack 616 and the headphones or recording equipment are releasably coupled to jack 614, the amplifier powers the headphones or recording equipment with a portion of the power supplied by the amplifier being absorbed by the resistors 640, 642 and 644, in order to maintain a proper load on the amplifier. The switch is movable to a second position wherein the amplifier coupled to the jack 614 powers a load connected to the terminals 638 in parallel with any load connected through jack 617. When moved to a central position, the switch 618 turns the switching device 610 off, so that no power is delivered from the amplifier to any loads, headphones or recording equipment. This latter feature is optional and not an essential element of the present invention. When it is not needed, the three way switch 618 can be replaced with a two way switch. Referring to FIG. 20, another embodiment of the present invention is generally designated by the reference number 710. The switching device 710 is similar to the switching device 10 with like elements being given like part numbers preceded by the reference number 7. In this embodiment, no switch is provided. To use headphones, an amplifier is coupled to jack 716 and a pair of headphones or recording equipment to jack 714 with no plug in jack 717. With the amplifier coupled to jack 716 and a plug inserted into jack 717, the load coupled to connectors 736 will be energized. Furthermore, in this case any load connected to jack 717 will be energized in parallel with the load connected to connectors 736.

While all of the components of the above-described switching device have been shown and described as discrete components being connected in the using wires, the present invention is not limited in this regard. A printed circuit board or even a chip configured to accomplish the operation described herein can be used without departing from the broader aspects of the present invention. Further, while the switching devices have all been depicted as mounting to a speaker cabinet, such as that used in a combination amplifier, it is clear that the switching device circuitry could be housed within the amplifier chassis as well without departing from the broader aspects of the present invention. In particular a switching device of the above-described type could be integrally assembled within the amplifier chassis.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above-detailed description, but that the invention will include all embodiments falling within the scope of the above description.

What is claimed is:

1. A switching device for exploiting impedance differences between at least two loads, said switching device comprising:
connection means for coupling a first and a second load to said switching device, said first and second loads cooperatively defining a virtual impedance;
coupling means defining at least one connection point for accepting an output from at least one source, said coupling means being in communication with said connection means; and
said connection means and said coupling means being cooperable to selectively cause said at least two loads to be switchably operable between at least two of the inherently different frequency responses comprised by said first load, said second load, their parallel interconnection, and their series interconnection.

2. A switching device as defined by claim 1 further comprising a switch in electrical communication with said connection means and said coupling means, said switch being movable between at least a first position wherein said at least two loads are interconnected in one of series and parallel and a second position wherein said at least two loads are connected in the other of series and parallel.

3. A switching device defined by claim 2 wherein:
said source is an amplifier; and
said coupling means include at least two jacks cooperable with said switch and said connection means so that when said amplifier output is releasably coupled to one of said jacks movement of said switch to one of said first and second positions causes said at least two loads to be connected in one of series and parallel, and releasably coupling said amplifier output to the other of said jacks and moving said switch to the other of said first and second positions causes said at least two loads to be connected in the other of series and parallel.

4. A switching device as defined by claim 1 wherein at least one of said at least two loads is a speaker transducer.

5. A switching device as defined by claim 4 wherein each of said at least two loads are speaker transducers.

6. A switching device as defined by claim 4 wherein the other of said at least two loads is a device used specifically to dissipate power (dummy load), such as a purely resistive element (e.g., power resistor).

7. A switching device as defined by claim 1 wherein said virtual impedance
$$( i . e . , {Z}_{v} = \frac{- {Z}_{Δ}^{2}}{{Z}_{s}} )$$
is exploited to produce variable output.

8. A switching device as defined by claim 3 wherein:
said switch is a three position switch movable between said first and second positions and a central position so that when said switch is in said central position said switch, said connection means and said jacks are cooperable such that an amplifier coupled to one of said at least two jacks causes only one of said loads to be operable.

9. A switching device as defined by claim 8 wherein coupling a second amplifier to another of said at least two jacks causes each of said speaker transducers to be independently operable.

10. A method for selectively exploiting impedance differences comprising the steps of:
providing at least a first and second load, said first and second loads possibly being identically rated;
determining that there is a difference between an impedance defined by said first load and an impedance defined by said second load;
determining a virtual impedance defined by said first and said second loads;
determining, for a particular situation, a desired interconnection configuration for said first and second loads based on their inherent impedance differences and the difference between the impedances of their series and parallel interconnections based on said virtual impedance;
selectively switching said first and second loads between different interconnection configurations to arrive at said desired interconnection configuration; and
operating said first and second loads in said desired interconnection configuration to generate a predetermined output.

11. A method for selectively exploiting impedance differences as defined by claim 10 wherein said virtual impedance is defined by
$${Z}_{v} = \frac{- {Z}_{Δ}^{2}}{{Z}_{s}} .$$

12. A method for selectively exploiting impedance differences as defined by claim 11 wherein said step of operating said first and second loads in said desired interconnection configuration includes providing signals receivable by said first and seconds loads, said signals being indicative of said predetermined output.

13. A method for selectively exploiting impedance differences as defined by claim 11 wherein said first load is a speaker transducer or speaker transducer network and said second load is a dummy load used for power dissipation.

14. A method for selectively exploiting impedance differences as defined by claim 10 wherein said first and second loads are each speaker transducers or speaker transducer networks.

15. A method for selectively exploiting impedance differences as defined by claim 11 wherein said step of selectively switching said first and second loads between different interconnection configurations to arrive at said desired interconnection configuration includes:
providing a switching device comprising:
connection means for coupling said first and said second loads to said switching device;
coupling means defining at least one connection point each for selectively receiving said signals, said coupling means being in communication with said connection means; and wherein
said connection means and said coupling means are cooperable to be switchably operable between at least two of the inherently different frequency responses between said first load, said second load, their series interconnection, and their parallel interconnection.

16. A switching device as defined by claim 3 further comprising:
a base plate; and wherein
said connection means, said at least two jacks and said multi-position switch are coupled to said base plate.

17. A switching device as defined by claim 16 wherein said base plate includes clamping means for releasably mounting said switching device to a structure (e.g., cabinet).

18. A switching device as defined by claim 17 wherein said clamping means is adapted to straddle a rail forming part of a cabinet.

19. A switching device as defined by claim 18 wherein said clamping means includes at least two extensions projecting outwardly from said base plate, and offset relative to one another so that said extensions can be positioned over and straddle said rail forming part of said cabinet, and wherein a fastener threadably extends through one of said extensions and defines an end engageable with said rail to releasably retain said switching device thereon.

20. A switching device as defined by claim 16 wherein said base plate defines a mounting flange extending around and projecting outwardly from a periphery of said base plate so that when said switching device is positioned in an opening located in a structure (e.g., cabinet) to which said switching device is to be mounted, said flange extends over and covers the peripheral edges of said opening.

21. A switching device as defined by claim 20 wherein said flange defines a plurality of openings, each for slidably receiving a portion of a fastener used to attach said switching device to said structure (e.g. cabinet).

22. A switching device as defined by claim 1 further comprising:
a base plate;
said coupling means including at least two jacks coupled to said base plate for releasably coupling an amplifier, and at least one of headphones and recording equipment, and speaker transducers;
a switch coupled to said base plate and moveable between at least a first and a second position said at least two jacks being in communication with said switch and said connection means; and wherein
at least one of said first and said second loads is a dummy load coupled to said base plate for absorbing power from an amplifier releasably coupled to said switching device.

23. A switching device as defined by claim 21 wherein said at least one of said first and said second loads is a speaker, said at least two jacks comprise three jacks, one jack for coupling one of headphones/and recording equipment to said switching device, a second jack for connecting an amplifier to said switching device, and a third jack for coupling a speaker network to said switching device, and wherein when said amplifier is coupled to said second jack and a plug is inserted in said third jack, said speaker network is operable.

24. A switching device as defined by claim 22 wherein:
said switch in said first position and said amplifier releasably coupled to one of said at least two jacks and one of said headphones and recording equipment is releasably coupled to the other of said at least two jacks said amplifier powers said headphones with a portion of the power being supplied by said amplifier being absorbed by said dummy load; and
said switch in second position wherein said amplifier coupled to one of said jacks powers said first load coupled to said connection means.

25. A switching device as defined by claim 22, wherein said at least two jacks include a third jack, said third jack being in electrical communication with said connection means sand said multi-position switch so that a second load releasably coupled to said third jack will be connected in parallel to said first load and powered by said amplifier when said switch is in said second position.

26. A switching device as defined by claim 22 wherein said base plate includes clamping means for releasably mounting said switching device to a speaker cabinet.

27. A switching device as defined by claim 24 wherein said clamping means includes three extensions projecting outwardly from said base plate, two of said extensions being substantially coplanar, the third of said extensions being offset relative to said coplanar extension and positioned there between so that said extensions can be positioned over and straddle a rail forming part of a speaker cabinet, and wherein a fastener threadably extends through said third extension and defines an end engageable with said rail to releasably retain said switching device thereon.

28. A switching device as defined by claim 22 wherein said base plate defines a mounting flange extending around and projecting outwardly from a periphery of said base plate so that when said switching device is positioned in an opening located in a structure (e.g., cabinet) to which said switching device is to be mounted, said flange extends over and covers the peripheral edges of said opening.

29. A switching device as defined by claim 18 wherein said clamping means is configured to prevent said switching device from protruding outwardly past said rail.
